(19) United States
(12) Patent Application Publication
(10) Pub. No.: US 2004/0005429 A1
(43) Pub. Date: Jan. 8, 2004

(54) Index control of punched carriers for containers

(76) Inventor: Arthur R. Slaters JR., Arlington Heights, IL (US)

Correspondence Address: Todd T. Taylor, Taylor & Aust, PC, 142 S. Main St., P.O. Box 560, Avilla, IN, 46710, US

(21) Appl. No.: 10/190,123

(22) Filed: Jul. 3, 2002

(51) Int. Cl. B26F 1/02; G09F 3/00

(52) U.S. Cl. 428/43; 264/153

(57) ABSTRACT

A process for forming plastic carriers for holding containers, and a web of the carriers formed in a press. To improve indexing of a web for punching, individual carriers are formed in the web in adjacent rows and ranks of carriers. The carriers remain connected in both rows and ranks until a rank is well outside of the punch press. Thereafter, carriers within a rank are separated, leaving individual rows of connected carriers.

### FIELD OF THE INVENTION

The present invention relates generally to carriers for containers; and, more particularly, the invention pertains to plastic carriers formed by punching from a web of plastic, and procedures for improving the indexing function in the punching process.

### BACKGROUND OF THE INVENTION

Container carriers are used frequently to unitize a plurality of containers, such as bottles or cans, into conveniently saleable quantities. Four packs and six packs are known and commonly available. Plastic carriers have achieved wide acceptance for their performance, low cost and versatility in being adapted for containers of different sizes and shapes.

The general design for plastic carriers includes the formation of apertures in a stretchable plastic. The apertures are sized and shaped to be stretched to engage the periphery of containers, either bottles or cans. Multiple rows of containers can be held in a single carrier. Automated machinery is available for attaching carriers to containers quickly and efficiently.

In a known design for carriers, each carrier is formed from two webs of plastic material juxtaposed over each other. Handle portions and container engaging portions are punched from the juxtaposed webs simultaneously. The webs are fused or welded along selected portions, such as by heat sealing. The resultant structure includes a handle portion of double thickness and a container engaging portion having arrays of loops formed in each sheet. An interconnecting, truss-like suspension portion interconnects the handle portion with the container holding portion. The individual arrays of container holding loops extend freely from the suspension portion.

It is known to form such carriers by superimposing elongated webs of the material, heat sealing or welding the webs together in selected locations and punching the desired carrier design into the webs. Processes known in the past include punching discrete rows of carriers in which each carrier is connected to adjacent carriers within a row. Depending on the size of the carrier being formed, and the width of the web of carrier material, a plurality of rows may be formed simultaneously in the web of material. To minimize problems associated with indexing variation as the web of material passes through the punch press, adjacent rows of carriers have been punched spaced from each other. As the web passes out of the punch press, the carriers are provided in discrete rows, and are subsequently wound onto separate supply spools.

Such carriers have achieved wide acceptance for use with six-packs of twelve ounce containers, for example. More recently, marketing demands have tended toward the packaging of larger volume containers and/or more containers in a single package. As a result, there is a demand for larger carriers, such as, for example, twelve-pack carriers in which two arrays of six loops are provided on each side of the suspension portion. Even with relatively small containers, a two row twelve-pack carrier of this type is significantly long. If larger containers are to be held in the carrier, the length may increase even more.

For speed and efficiency in manufacture, it is common to punch at least one entire carrier with each stroke of the press, and index the web forward by at least one carrier length in preparation for the next stroke. As the length of the carriers increases, the indexing stroke increases, and errors in indexing are magnified. An additional problem is that the punched rows of carriers can “wander” exiting the punch press, resulting in misalignment of the unpunched portion of the web, and malformation of portions in subsequent carriers punched in the web.

As can be appreciated, the location, size and shape of the loops for holding the containers are critical to proper functioning of the carrier. An undersized, oversized, wrongly located, or malformed loop may inadequately retain a container, allowing the container to fall from the carrier. Failure of a carrier in the automatic machinery attaching a carrier to the containers can cause significant difficulties, and significantly curtail output. Failure during transport of the assembled package, at best, is inconvenient

Therefore, it is desirable to provide improved indexing control for punching carriers in elongated webs of carrier materials, to improve accuracy of carrier formation.

### SUMMARY OF THE INVENTION

The present invention provides improved indexing of web material during a punching process for plastic container carriers by punching carriers immediately adjacent each other in both rows and ranks, and retaining interconnection between adjacent carriers in both rows and ranks until the web has moved well out of the punch press.

The invention provides, in one form thereof, a method of forming plastic carriers for containers, with steps of providing a web of carrier material, forming carriers in the web in adjacent rows and adjacent ranks, and advancing the web of formed carriers. Adjacent carriers in a row remain connected to each other, and adjacent carriers in a rank remain connected to each other during the step of advancing the web of formed carriers. After advancing the web of formed carriers, carriers within a rank are separated, to leave only carriers interconnected in rows.

In another form thereof, the invention provides a method of forming plastic carriers for containers, with steps of providing a web of plastic for forming the carriers; advancing the web through a press; and punching individual carrier configurations into the web. The step of punching includes creating adjacent rows and ranks of interconnected carriers; and advancing interconnected rows and ranks of carriers away from the press. Thereafter, carriers within a rank are separated to provide discrete rows of carriers.

In still another form thereof, the invention provides a web of plastic carriers for holding containers. The web has a plurality of adjacent rows of carriers, each row including a plurality of carriers connected to each other. Adjacent carriers of adjacent rows are connected to each other, forming adjacent ranks of connected carriers.

In a further form thereof, the invention provides a method for forming plastic carriers for containers, with steps of providing a web of plastic material and a punch press with dies for forming carriers in the web; advancing the web to the press; punching carriers in the web in interconnected rows and ranks of carriers; advancing the punched, interconnected rows and ranks of carriers away from the press; and, away from the press, separating the carriers in a rank to leave carriers connected in separate rows.

An advantage of the present invention is improved index control of webs advancing through a punch press.

Another advantage of the present invention is better utilization of material in a web during a punch press process for container carriers.

Yet another advantage of the present invention is providing a more accurate punch press process.

Still another advantage of the present invention is providing a web of carriers interconnected in both rows and ranks that are readily separable into separated rows for accumulating for shipping:

Other features and advantages of the invention will become apparent to those skilled in the art upon review of the following detailed description, claims and drawings, in which like numerals are used to designate like features.

### BRIEF DESCRIPTION OF THE DRAWINGS

FIG. 1 is a plan view, partially broken away, of a web of container carriers according to the present invention, with one rank of carriers having been punched into the web, and a second rank to be punched illustrated in phantom lines;

FIG. 2 is a plan view of the process of the present invention; and

FIG. 3 is a flow chart of steps in the present process.

Before the embodiments of the invention are explained in detail, it is to be understood that the invention is not limited in its application to the details of construction and the arrangements of the components set forth in the following description, or illustrated in the drawings. The invention is capable of other embodiments and of being practiced or being carried out in various ways. Also, it is understood that the phraseology and terminology used herein are for the purpose of description, and should not be regarded as limiting. The use herein of “including”, “comprising” and variations thereof is meant to encompass the items listed thereafter, and equivalents thereof, as well as additional items and equivalents thereof.

### DETAILED DESCRIPTION OF THE PREFERRED EMBODIMENT

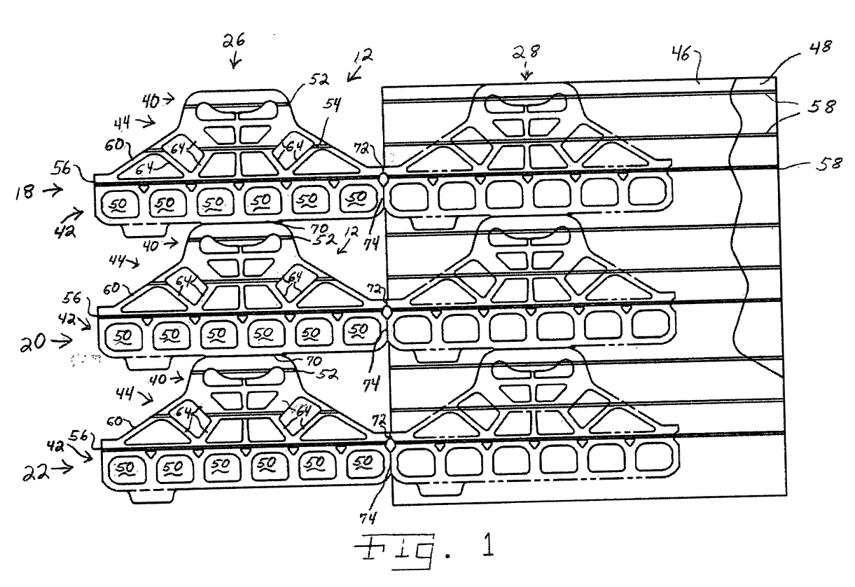

Referring now more specifically to the drawings, and to FIG. 1 in particular, numeral 10 designates a web of material for making carriers 12 to secure containers such as bottles, cans or the like. As shown in FIG. 1, web 10 has been partially punched in accordance with the present invention.

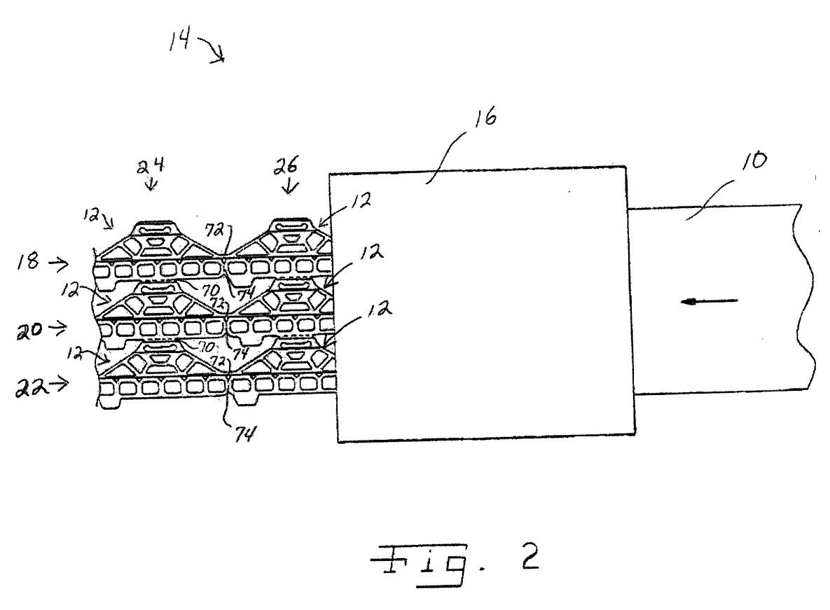

A process 14 (FIG. 2) according to the present invention is performed in a punch press 16 through which web 10 is advanced. In a periodic manner, dies in the press are brought together to punch a desired configuration for carriers 12 into web 10. Each carrier 12 is similar to the next carrier 12 in size, shape and overall configuration. Carriers 12 are punched in continuous rows 18, 20 and 22 along the length of web 10. While three such rows 18, 20 and 22 are shown in the drawings, it should be understood that the number of rows formed in each web 10 will depend on the size of the carrier and the width of the web.

As carriers 12 are formed in web 10, aligned ranks of carriers are formed. across the width of the web. FIG. 2 illustrates a downstream rank 24 of three carriers 12 and an upstream rank 26 similar to downstream rank 24. In FIG. 1, only upstream rank 26 is shown, and an as yet unformed rank 28 is illustrated by phantom lines.

As mentioned previously, each carrier 12 is similar in size, shape and structure to other carriers 12. Generally, each carrier 12 includes a handle portion 40, a container holding portion 42 and a truss-like suspension portion 44 connecting handle portion 40 to container holding portion 42. The actual configuration for carriers 12 will vary depending upon the size, type and quantity of containers to be held by carriers 12. In the exemplary carrier 12 shown in the drawings, each carrier 12 is a two-ply structure, with web 10 having been formed of a top sheet 46 and a bottom sheet 48 (FIG. 1). Each carrier 12 includes twelve apertures 50 in the nature of adjacent loops that can be stretched to surround the container to be held.

It should be understood that in the views illustrated in FIGS. 1 and 2, only the six apertures 50 formed in top sheet 46 are readily visible. However, since top sheet 46 and bottom sheet 48 are juxtaposed over each other, and punched simultaneously, the bottom sheet not visible in the punched portions illustrated of carrier 12 will also include six similar apertures 50. Each such aperture 50 in top sheet 46 and bottom sheet 48 is used to secure a container therein, so that each carrier 12 can hold twelve containers.

Top sheet 46 and bottom sheet 48 are secured to each other by a plurality of welds 52, 54 and 56 formed in each carrier 12. The manner in which such welds can be made is well known to those skilled in the art, and may include the application or extrusion of a strip 58 of material similar to the material in top sheet 46 and bottom sheet 48. Several of the strips 58 are shown in FIG. 46. The layers of plastic material, including top sheet 46, bottom sheet 48 and extruded strip 58 are melted together such as by the application of heat and pressure to cause a sealing or fusing between the layers, to form a strong, integral bond between sheets 46 and 48.

Suspension portion 44 includes a plurality of struts 60, 62, 64, including first and second end struts 60 and 62, respectively, and various intermediate or center struts 64. The present invention is particularly advantageous when used with long carriers, and center top-lift carriers, such as carrier 12 illustrated in which six bottles are held in a single row. In such carriers 12, a preferred suspension portion includes end struts 60 and 62 which extend angularly outwardly from handle portion 40 to near the outer edges of container holding portion 42.

As successive ranks 24 and 26 are formed in rows 18, 20 and 22, adjacent carriers 12 within the rows and ranks remain connected to each other. Thus, for example, within rank 26 illustrated in FIG. 1, carrier 12 within row 20 remains connected to adjacent carriers 12 within rows 18 and 22. Handle portion 40 of carrier 12 within row 20 remains connected to container holding portion 42 of carrier 12 within row 18, and container holding portion 42 of carrier 12 within row 20 remains connected to handle portion 40 of carrier 12 within row 22. Preferably, the connections between carriers 12 within each rank are formed as a readily frangible link 70, such as a perforate line punched in sheets 46 and 48 at the desired separation line between adjacent carriers 12.

Within each row 18, 20 and 22, adjacent carriers 12 remain connected to each other. Thus, as illustrated in FIG. 2, carrier 12 of rank 24 in row 18 remains connected to carrier 12 of rank 26 in row 18. Similarly, the adjacent carriers 12 in row 20 remain connected to each other, and adjacent carriers 12 in row 22 also remain connected to each other. In the exemplary embodiment shown, the connection between adjacent carriers 12 within each row 18, 20 and 22 comprise a pair of frangible links 72 and 74 spaced from each other. Frangible links 72 and 74 are disposed on opposite sides of weld 56. Preferably, each frangible link 72 and 74 is also formed as a perforate line at the desired separation points between adjacent carriers 12 within each row 18, 20 and 22.

The manner in which perforate lines may be created in sheets 46 and 48 during the punching process to create frangible links 70, 72 and 74 is well known to those skilled in the art, and will not be described in detail herein.

In accordance with the present invention, adjacent carriers 12 remain connected in both rows and ranks until web 10 is moved some distance away from press 16. Retaining connections between carriers 12 within each rank 24, 26 retains side to side integrity of web 10. By maintaining the side-to-side integrity of web 10, rows 18, 20 and 22 can not wander or deviate relative to each other, but progress as a continuous unit out of press 16. Thus, web 10 remains flat and properly oriented in press 16 such that carriers 12 newly formed are properly oriented with respect to adjacent carriers in both rows and ranks, and each carrier is properly shaped.

At some distance away from press 16, frangible links 70 within each rank are fractured such that rows 18, 20 and 22 become separated from each other. Each row 18, 20 and 22 of carrier 12 can then be individually wound on spools, fan folded in containers, or otherwise accumulated in volume for use on automated machinery designed for application of carriers 12 to containers to be held thereby. Severing frangible links 70 within a rank, and separation of rows 18, 20 and 22 should occur far enough from press 16 so that the flatness of web 10 in press 14 is not affected adversely.

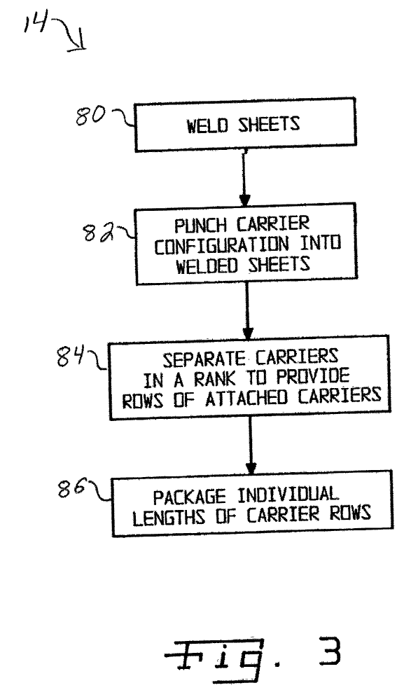

FIG. 3 illustrates in flow chart form, steps of an embodiment of process 14 in which sheets 46 and 48 are welded in a first step 80, the desired carrier configuration is punched into the welded sheets in a second process step 82. Carriers within a rank are separated to provide attached rows of carriers in a third process step 84, and individual lengths of carrier rows are packaged in a process step 86. It is to be understood that various steps within the process may be performed in different order. For example, welding of the sheets can occur after punching the carriers and/or essentially simultaneously therewith. However, in accordance with the present invention, carriers 12 remain attached in both rows 18, 20 and 22 and ranks 24 and 26 until the ranks are moved well out of press 16 sufficiently to retain proper indexing and orientation of web 10 within press 16.

The present invention provides a process and carrier web structure to facilitate proper indexing of the web during a punching process. Since adjacent rows are formed immediately adjacent each other, i.e., contiguous with each other, better utilization of the web is achieved than by processes in which the rows are punched separate from each other, and at some distance apart. Further, processes for forming long carriers such as, for example, carriers having six or more aligned apertures for holding containers, can maintain proper orientation and indexing of the web during the punching process.

Variations and modifications of the foregoing are within the scope of the present invention. It is understood that the invention disclosed and defined herein extends to all alternative combinations of two or more of the individual features mentioned, or evident from the text and/or drawings. All of these different combinations constitute various alternative aspects of the present invention. The embodiments described herein explain the best modes known for practicing the invention, and will enable others skilled in the art to utilize the invention. The claims are to be construed to include alternative embodiments, to the extent permitted by the prior art.

Various features of the invention are set forth in the following claims.

What is claimed is:

1. A method of forming plastic carriers for containers, said method comprising steps of:
providing a web of carrier material;
forming carriers in the web in adjacent rows and adjacent ranks, with adjacent carriers in a row remaining connected to each other and adjacent carriers in a rank remaining connected to each other;
advancing the web of formed carriers; and
after forming said carriers in adjacent rows and adjacent ranks, and after advancing the web of formed carriers, separating carriers within a rank to leave only carriers interconnected in rows.

2. The method of claim 1, including forming said carriers immediately adjacent each other in both rows and ranks.

3. The method of claim 2, including perforating the web to provide a frangible intersection of adjacent carriers.

4. The method of claim 3, said forming step including forming carriers in aligned rows.

5. The method of claim 1, said forming step including forming carriers in aligned rows.

6. The method of claim 5, including forming said carriers immediately adjacent each other in both rows and ranks.

7. The method of claim 1, including providing said web as first and second sheets juxtaposed on each other, and welding said sheets together.

8. A method of forming plastic carriers for containers, said method comprising steps of:
providing a web of plastic for forming said carriers;
advancing said web through a punch press;
punching individual carrier configurations into said web, said punching including creating adjacent rows and ranks of interconnected carriers;
advancing interconnected rows and ranks of carriers away from the press; and
thereafter separating carriers within a rank to provide discrete rows of carriers.

9. The method of claim 8, including perforating the interconnected region between adjacent carriers within a rank.

10. The method of claim 8, including perforating the interconnected regions of adjacent carriers within a row.

11. The method of claim 10, including perforating the interconnected region between adjacent carriers within a rank.

12. The method of claim 11, said step of providing a web including providing first and second sheets juxtaposed on each other, and connecting the first and second sheets together.

13. The method of claim 8, said step of providing a web including providing first and second sheets juxtaposed on each other, and connecting the first and second sheets together.

14. A web of plastic carriers for holding containers, said web comprising:
a plurality of adjacent rows of carriers, each said row of carriers including a plurality of carriers;
said carriers within each row being connected to each other; and
adjacent carriers of adjacent rows being connected to each other and forming adjacent ranks of connected carriers.

15. The web of carriers of claim 14, including perforations between adjacent carriers within each row.

16. The web of carriers of claim 14, including perforations between adjacent carriers in each rank.

17. The web of carriers of claim 16, including perforations between adjacent carriers within each row.

18. The web of carriers of claim 17, said web including first and second sheets in juxtaposition.

19. The web of carriers of claim 14, said web including first and second sheets in juxtaposition.

20. A method for forming plastic carriers for containers, comprising steps of:
providing a web of plastic material and a punch press with dies for forming carriers in the web;
advancing the web to the press;
punching carriers in the web in interconnected rows and ranks of carriers;
advancing the punched, interconnected rows and ranks of carriers away from the press; and
away from the press, separating the carriers in a rank to leave carriers connected in separate rows.

21. The method of claim 20, including perforating the web between adjacent carriers in both rows and ranks.
